(19) United States
(12) Patent Application Publication
(10) Pub. No.: US 2025/0027552 A1
(43) Pub. Date: Jan. 23, 2025

(54) SPRING COUPLER AND CROSSOVER DAMPER

(71) Applicant: Fox Factory, Inc., Duluth, GA (US)

(72) Inventors: Nathaniel Lundstrom, Santa Cruz, CA (US); Edwin Blake Nicholas, Elbert, CO (US)

(73) Assignee: Fox Factory, Inc., Duluth, GA (US)

(21) Appl. No.: 18/643,861

(22) Filed: Apr. 23, 2024

Related U.S. Application Data
(60) Provisional application No. 63/547,904, filed on Nov. 9, 2023.
(60) Provisional application No. 63/527,288, filed on Jul. 17, 2023.

(51) Int. Cl. F16F 13/00; B60G 15/06; F16F 3/02

(52) U.S. Cl. CPC F16F 13/007; F16F 3/026; B60G 15/065

(57) ABSTRACT

A dual rate spring system is disclosed. The dual rate spring system can include a first spring and a spring coupler that have different spring rates. The dual rate spring system can include a two piece crossover ring, a two piece spring coupler, or both. The two piece crossover ring can include a first damper. The two piece spring coupler can include a second damper. The first and second damper can reduce a noise or harshness of jolt associated with a transition from the first spring to the second spring.

### CROSS-REFERENCE TO RELATED APPLICATIONS

This application claims priority to and benefit of co-pending U.S. Provisional Patent Application No. 63/527,288 filed on Jul. 17, 2023, entitled “SPRING CROSSOVER NOISE REDUCTION” by Lundstrom, and assigned to the assignee of the present application, the disclosure of which is hereby incorporated by reference in its entirety.

This application also claims priority to and benefit of co-pending U.S. Provisional Patent Application No. 63/547,904 filed on Nov. 9, 2023, entitled “SPRING CROSSOVER NOISE REDUCTION” by Lundstrom, and assigned to the assignee of the present application, the disclosure of which is hereby incorporated by reference in its entirety.

### FIELD OF THE INVENTION

Embodiments of the present technology relate generally to a spring coupler and crossover damper for spring crossover noise reduction.

### BACKGROUND

Shock assemblies (e.g., dampers, shock absorbers, springs etc.) are used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force can be significantly reduced or even absorbed completely before it is transmitted to a person on a seat of the vehicle. Certain shock absorbers utilize a coil spring or a plurality of coil springs to affect operating characteristics of the damper.

### BRIEF DESCRIPTION OF THE DRAWINGS

Aspects of the present invention are illustrated by way of example, and not by way of limitation, in the accompanying drawings, wherein:

FIG. 1A, is a side view of dual rate spring system, shown in accordance with an embodiment.

FIG. 1B, is a cross-section view of dual rate spring system, shown in accordance with an embodiment.

FIG. 2, is a perspective view of dual rate spring system, shown in accordance with an embodiment.

FIG. 3A, is a cross section view of a dual rate spring system with a two piece crossover ring with a damper in a nearly fully extended state, shown in accordance with an embodiment.

FIG. 3B, is a cross section view of dual rate spring system partially compressed, shown in accordance with an embodiment.

FIG. 3C, is a cross section view of dual rate spring system with a fully compressed cavity, shown in accordance with an embodiment.

FIG. 4, is a cross section view of dual rate spring system with a two piece spring coupler, shown in accordance with an embodiment.

FIG. 5, is a cross section view of dual rate spring system with a two piece spring coupler, shown in accordance with an embodiment.

FIG. 6, is a cross section view of a dual rate spring system with a two piece spring coupler including a gas chamber, shown in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

### Dual Rate Spring System

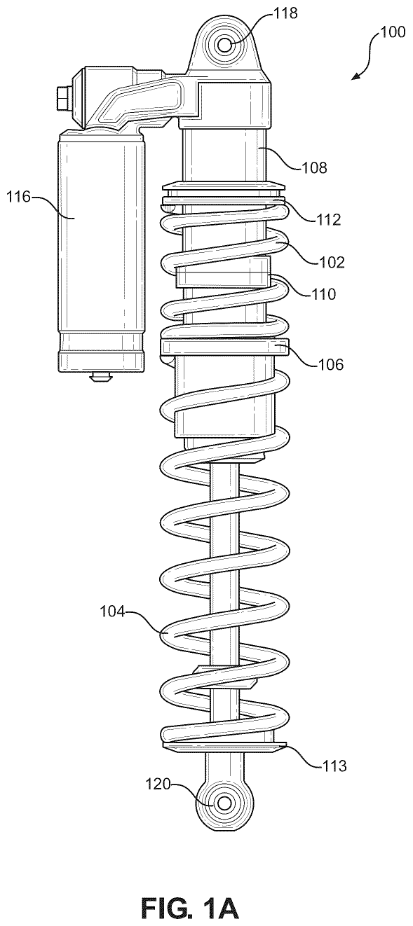

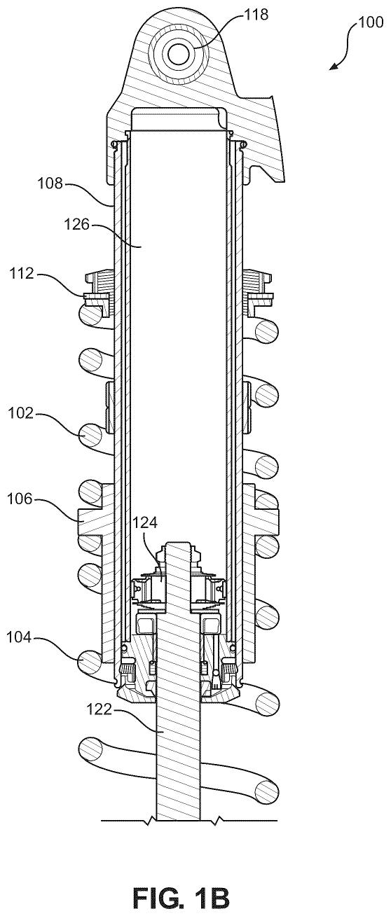

Referring now to FIG. 1A, a side view of dual rate spring system 100. Dual rate spring system 100 can be installed on a vehicle as part of a suspension system for the vehicle. Dual rate spring system 100 includes a first spring 102, a second spring 104, a spring coupler 106, a damper body 108, a crossover ring 110, a top retainer 112, and an additional reservoir 116.

Dual rate spring system 100 is depicted as having two springs. For purposes of brevity and clarity, the present Detailed Description of Embodiments and the corresponding Figures will refer to a dual rate spring system, It should be noted, however, the various embodiments of the present invention are also well-suited to use in spring systems having more than two springs. Referring again to FIG. 1A, in one embodiment, first spring 102 is a tender spring and second spring 104 is a primary spring. It will be understood that a spring is defined as having a spring constant which is represented as “k”. The spring constant, k, generally refers to the overall stiffness of a spring. More specifically, the spring constant, k, corresponds to the amount of force required to stretch or compress the spring a given distance. Hence, the higher the spring constant, k, the greater the force required to stretch or compress the spring a given distance. For example, a tender spring may have a spring rate or k value that is lower than a spring rate or k value of the primary spring. First spring 102 can be coupled to second spring 104 via spring coupler 106. Spring coupler 106 can have first spring seat 107 which is a first surface feature for receiving an end of first spring 102 and a second spring seat 109 which is a second surface feature for receiving and end of second spring 104. For example, the first and second surface feature can have flanges and shapes designed for an end of a spring to nestle into a groove, shoulder, or spring seat of the surface feature. First spring 102, second spring 104, and spring coupler 106 can each radially surround damper body 108 as depicted. Spring coupler 106 can have an annular structure disposed about an outer surface of damper body 108 and move or slide axially up and down a surface of damper body 108 during operations of dual rate spring system 100 such as compression or rebound events.

During a compression event, second spring 104 and spring coupler 106 can move axially up damper body 108 and compress first spring 102. First spring 102 can be prevented from moving off of damper body 108 via top retainer 112. A Top retainer 112 can be coupled to or fixed relative to damper body 108. A bottom retainer 113 can be in contact with a bottom of second spring 104 and prevent second spring 104 from moving off of damper body 108. In one embodiment, second spring 104 has a greater spring rate than first spring 102 and therefore second spring 104 may not compress before first spring 102. During a compression of first spring 102, spring coupler 106 can contact crossover ring 110 and prevent or stop first spring 102 from compression further. Crossover ring 110 can have an annular structure disposed about an outer surface of damper body 108 and is fixed or coupled to damper body 108 at a point along an axial length of damper body 108 such that crossover ring 110 may not move after being contacted by spring coupler 106. A position of crossover ring 110 on a surface along an axial length of damper body 108 can be moved such that crossover ring 110 can be unfixed or uncoupled from a first position and moved to a second position along damper body 108 where crossover ring 110 is fixed or coupled to damper body 108. After spring coupler 106 has contacted crossover ring 110 during the compression event, second spring 104 can compress. Thus dual rate spring system 100 can experience two different spring force curves due to the two different spring rates of first spring 102 and second spring 104.

Additional reservoir 116 can include a chamber for additional fluid or gas. Eyelet mount 118 and eyelet mount 120 can be employed to mount dual rate spring system 100 to a vehicle. In operation, when the suspension encounters a bump, dual rate spring system 100 enters a compression stage where the distance between eyelet mount 118 and eyelet mount 120 is reduced as the length first spring 102 and/or second spring 104 is compressed. After the compression stage, dual rate spring system 100 enters a rebound stage where first spring 102 and/or second spring 104 provides a pressure on dual rate spring system 100 to return to its resting size.

In general, a dual rate spring system can have an initial lighter stiffness rate for regular operation, but will transition to a harder stiffness rate upon encounter of a compression causing event. For example, the initial stiffness of dual rate spring system 100 will be soft due to the softer spring force of first spring 102 as compared to second spring 104. As dual rate spring system 100 compresses, so will first spring 102 and second spring 104, until a point where spring coupler 106 will be stopped by crossover ring 110. In general, crossover ring 110 is located at a point before first spring 102 is fully compressed. Once spring coupler 106 meets crossover ring 110, first spring 102 is no longer part of the spring stiffness calculation and the rest of the spring compression is placed on second spring 104. At that time, the spring rate is increased to the spring stiffness of second spring 104.

In general, by adjusting a position of crossover ring 110, the length of the damper stroke at the first spring rate is defined. For example, if dual rate spring system 100 has a 12 inch stroke and the crossover point is set at 6″ of stroke, the system will use the lighter spring rate of first spring 102 for the first 6 inches of travel and then transition to the heavier spring rate of second spring 104 for any remaining compression. Thus, as different terrain is encountered, the ability to adjust the location of crossover ring 110 (and thus the length), is important to damper performance, ride quality, and possibly component or system damage.

Referring now to FIG. 1B, a cross-section view of dual rate spring system 100. During a compression event, a damping rod 122 can move axially up into a damping chamber 126 of damper body 108. Damping rod 122 is coupled with a damping piston 124 that moves telescopically into and out of damping chamber 126 in an axial direction. As damping piston 124 moves into damping chamber 126, the volume of damping chamber 126 is reduced and fluid in damping chamber 126 can be displaced. For example, the fluid can be displaced into additional reservoir 116 which is in fluid communication with damping chamber 126. Fluid communication between damping chamber 126 and additional reservoir 116 may be via a flow channel including an adjustable needle valve.

In one embodiment, additional reservoir 116 has a fluid filled portion and a gas filled portion separated by an internal floating piston. Fluid entering additional reservoir 116 can move the internal floating piston to compress gas in the gas filled portion to compensate for a reduction in volume in damping chamber 126 as damping rod 122 moves into damping chamber 126. In one embodiment, dual rate spring system 100 does not include additional reservoir 116.

In one embodiment, during the compression event, damping rod 122 and damping piston 124 move axially with second spring 104 as second spring 104 moves axially up and is compressed after spring coupler 106 contacts crossover ring 110. It should be appreciated that that damping chamber 126 including the fluid, damping piston 124, and additional reservoir 116 work together to dampen spring forces of first spring 102 and second spring 104. In its basic form, the damper works in conjunction with the helical springs and controls the speed of movement of the damping rod by metering incompressible fluid from one side of the damper piston to the other, and additionally from damping chamber 126 to additional reservoir 116, during a compression stroke (and in reverse during the rebound or extension stroke).

Crossover Ring with an Isolator

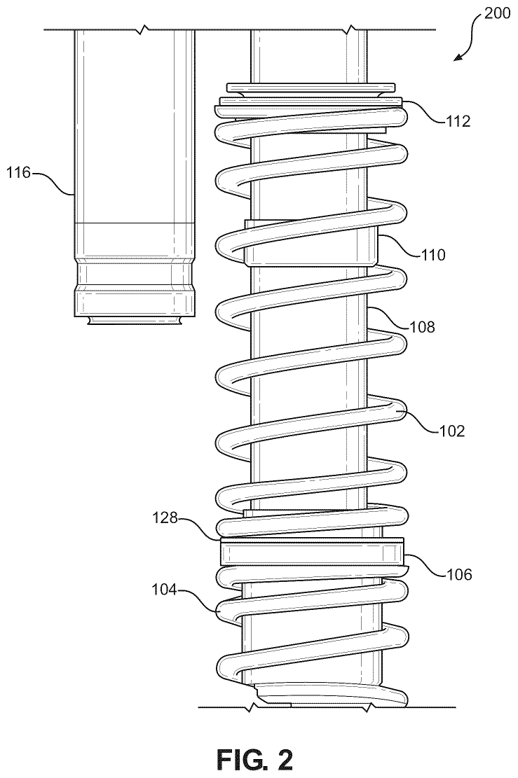

Referring now to FIG. 2, a perspective view of dual rate spring system 200 with a crossover isolator 128. In one embodiment, during a compression event, when spring coupler 106 contacts crossover ring 110, a noise may be heard such as a clacking sound and a jolt may be felt by passengers in a vehicle employing dual rate spring system 100. To reduce such a noise and jolt, dual rate spring system 200 includes crossover isolator 128. Crossover isolator 128 can be a bumper. The crossover isolator can have an annular structure disposed about a surface of damper body 108. Crossover isolator 128 can be attached, adhered, pressure fit, or otherwise coupled to a top surface of spring coupler 106. Crossover isolator 128 can be composed of a material that has a cushioning effect when compressed such as a foam, rubber, or elastomer. When spring coupler 106 approaches crossover ring 110 during a compression event, crossover isolator 128 can first contact crossover ring 110 and deform between the pressure of spring coupler 106 moving to meet the fixed position of crossover ring 110. The deforming of crossover isolator 128 can cushion a contact between spring coupler 106 and crossover ring 110 and thus reduce a noise or dampen a harshness of a jolt associated with spring coupler 106 contacting crossover ring 110.

Two Piece Crossover Ring with a Damper

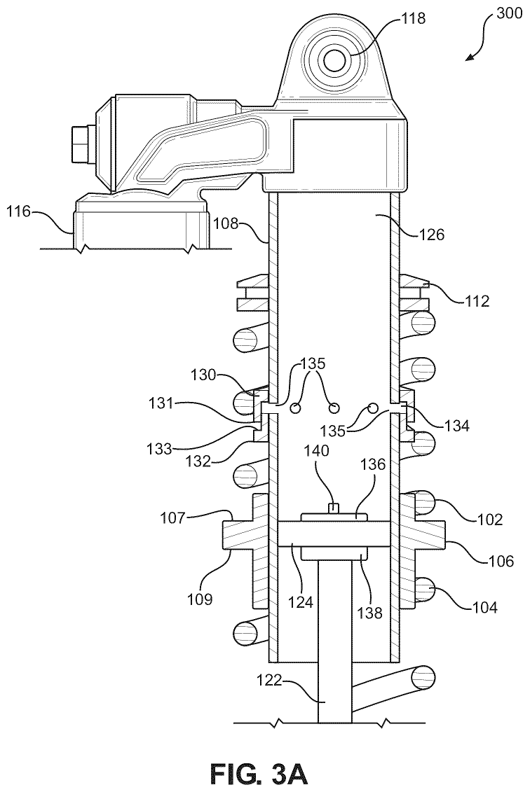

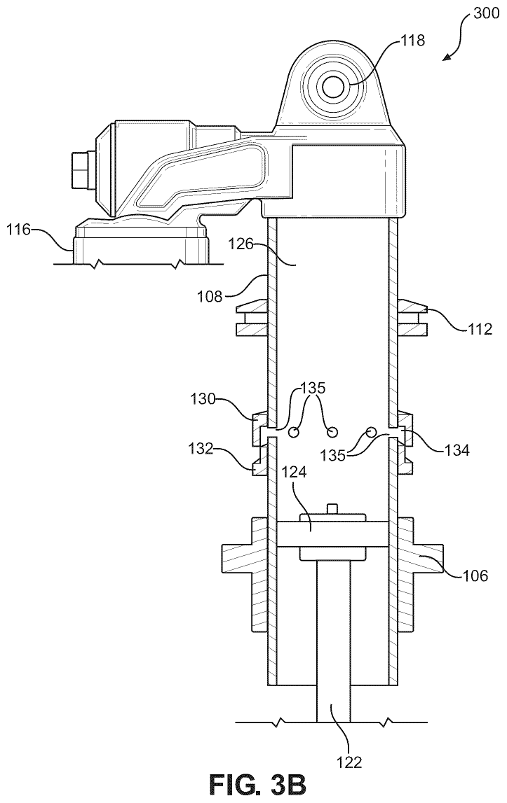

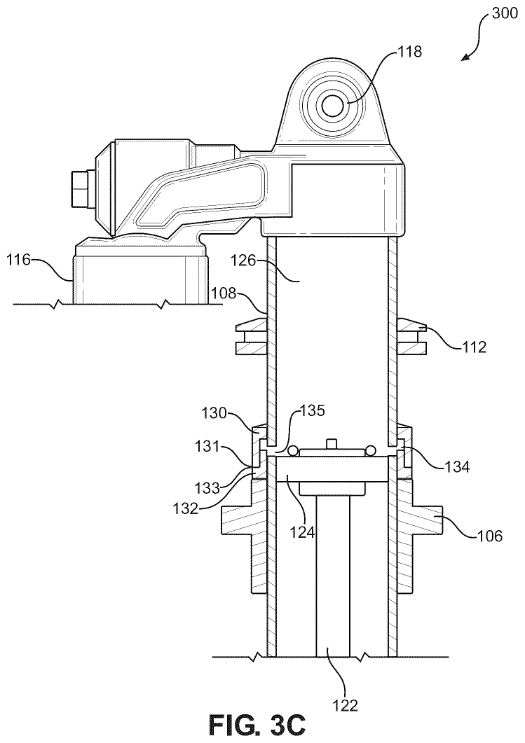

Referring now to FIG. 3A, cross section view of a dual rate spring system 300 with a two piece crossover ring with a damper in a nearly fully extended state. The two piece crossover ring can be composed of two separate pieces including upper ring portion 130 and lower ring portion 132. In one embodiment, upper ring portion 130 can be fixed or coupled to damper body 108 to be rigid with respect to damper body 108. Lower ring portion 132 can be movable with respect to upper ring portion 130. In one embodiment, upper ring portion 130 and lower ring portion 132 can be shaped to form a cavity 134. Upper ring portion 130, lower ring portion 132, and cavity 134 can have an annular structure disposed about an outer surface of damper body 108 to form a ring shape. Cavity 134 can change in shape and volume as lower ring portion 132 is moved with respect to upper ring portion 130.

Damping piston 124 is depicted has having an upper shim stack 136 and a lower shim stack 138 as well as a fastener 140. The upper shim stack 136, lower shim stack 138, and fastener 140, can be used to control a damping effect of damping piston 124 as damping piston 124 moves into and out of damping chamber 126.

Damper body 108 can have a plurality of ports, such as ports 135, positioned radially about an outer surface of damper body 108 at a point located along an axial length of damper body 108. Ports 135 can allow fluid communication, meaning fluid flow, of a fluid in damping chamber 126 into cavity 134. For example, as damping piston 124 can move axially into damping chamber 126 during a compression event, fluid in damping chamber 126 can move into cavity 134 and cause the volume of cavity 134 to expand. Fluid flowing into cavity 134 can cause or force lower ring portion 132 to move away from upper ring portion 130. A retaining ring, clip, or other type of fastener can provide a stopping point for a movement of lower ring portion 132 and prevent lower ring portion 132 from completely separating from upper ring portion 130. In one embodiment, cavity 134 is sealed. Thus, cavity 134 may not open and expel the fluid from a point other than ports 135. Changing an amount of fluid flowing into and out of cavity 134 can tune the damping effect of the two piece crossover ring. For example, a number of the ports can be increased or decreased to change fluid flow or the size of the ports can be increased or decreased to change fluid flow.

In one embodiment, fluid pressure in cavity 134 is dependent upon damping piston 124 position within damping chamber 126. For example, pressure in cavity 134 can be dependent on shaft position of damping rod 122 and can vary the force that spring coupler 106 will react against when transitioning spring rates between first spring 102 and second spring 104. In one embodiment, orifice flow of the fluid in ports 135 varies a speed of spring coupler 106 during spring rate transition between first spring 102 and second spring 104.

As first spring 102 compresses during a compression event, spring coupler 106 can contact lower ring portion 132. Lower ring portion 132 can then be forced to move upward toward upper ring portion 130 thus reducing the volume of cavity 134 and causing fluid in cavity 134 to flow back into damping chamber 126 through ports 135. The movement of lower ring portion 132 can occur until surface 131 of upper ring portion 130 contacts surface 133 of lower ring portion 132 thus stopping a movement of lower ring portion 132. The contact of second spring 104 with lower ring portion 132 and causing the fluid to flow back to damping chamber 126 can cause a damping effect on spring coupler 106 contacting lower ring portion 132. Thus, a noise and harshness of a jolt associated with spring coupler 106 contacting the two piece crossover ring can be reduced.

Upper ring portion 130 and lower ring portion 132 are depicted in a partially compressed state for the two piece crossover ring. The partially compressed state may be a resting state of the two piece crossover ring. A fully compressed state of the two piece crossover ring can be when surface 131 of upper ring portion 130 contacts surface 133 of lower ring portion 132. A fully extended state of two piece crossover ring can occur when damping piston 124 causes the fluid to flow into cavity 134 and lower ring portion 132 moves relative to upper ring portion 130 to a lowest position possible.

Referring now to FIG. 3B, a cross section view of dual rate spring system 300 with lower ring portion 132 fully extended from upper ring portion 130 and cavity 134 at a maximum volume. First spring 102 and second spring 104 are not depicted in FIG. 3A for simplicity. FIG. 3A depicts a partially compressed stage of a compression event where damping piston 124 and damping rod 122 have moved partially into damping chamber 126 and thus displaced fluid into cavity 134 via ports 135 causing lower ring portion 132 to fully extend away from upper ring portion 130.

Referring now to FIG. 3C, a cross section view of dual rate spring system 300 with cavity 134 fully compressed and at a minimum volume. Damping piston 124 has moved further into damping chamber 126 as compared to FIG. 3B during the compression event. Spring coupler 106 is in contact with lower ring portion 132 and surface 133 of lower ring portion 132 is in contact with surface 133 of upper ring portion 130. The ports 135 are depicted as being partially covered by lower ring portion 132. In one embodiment, the ports 135 may not be covered or partially covered by lower ring portion 132 when cavity 134 is at a minimum volume. During a rebound event, damping piston 124 and lower ring portion 132 can return to resting positions.

Two Piece Spring Coupler with a Bumper

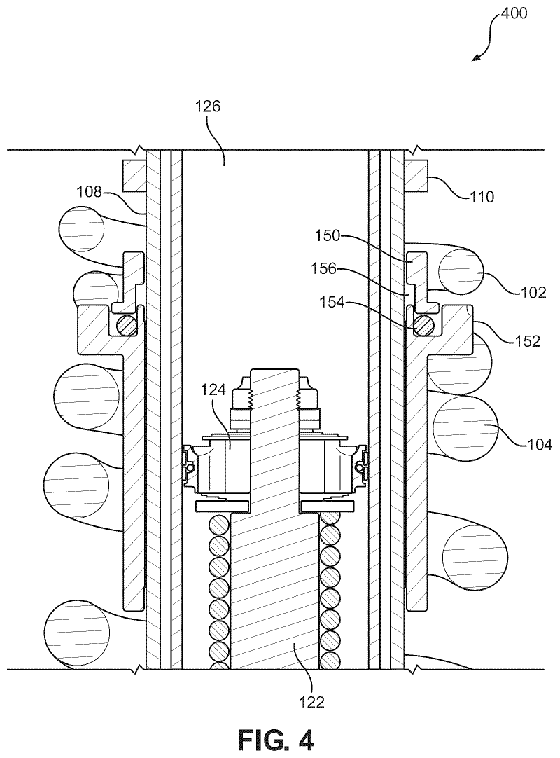

Referring now to FIG. 4, a cross section view of dual rate spring system 400 with a two piece spring coupler. Dual rate spring system 100 can be a dual spring system that includes first spring 102 and second spring 104 joined together via a two piece spring coupler. The two piece spring coupler can include an upper coupler portion 150 and a lower coupler portion 152. Upper coupler portion 150 and lower coupler portion 152 can have an annular structure disposed about an outer surface of damper body 108 and can move or slide axially up and down damper body 108 during a compression event of dual rate spring system 400.

In one embodiment, positioned between upper coupler portion 150 and lower coupler portion 152 can be a bumper 154. The bumper 154 can be composed of a cushioning material such as foam, rubber, elastomer, etc. In one embodiment, lower coupler portion 152 can be shaped with an radial groove that is open on a top portion such that bumper 154 can sit in the radial groove and a portion of upper coupler portion 150 can fit in the radial groove positioned on top of bumper 154. Upper coupler portion 150 and lower coupler portion 152 can be shaped to form a cavity 156. FIG. 4 depicts dual rate spring system 400 in a fully or nearly fully extended state where cavity 156 is at a maximum volume and bumper 154 is uncompressed.

In one embodiment, the components of two piece spring coupler, including upper coupler portion 150, lower coupler portion 152 and bumper 154 can be force balanced such that the components of the two piece spring coupler can travel together as a single unit up and down damper body 108. Once the two piece spring coupler contacts crossover ring 110, lower coupler portion 152 may then move relative to upper coupler portion 150.

During a compression event, second spring 104, in contact with a flange of lower coupler portion 152, can cause lower coupler portion 152 and upper coupler portion 150 to move or slide up damper body 108. Upper coupler portion 150 can slide upward until contacting crossover ring 110 that may be fixed relative to damper body 108. Upon contacting crossover ring 110, upper coupler portion 150 may stop movement and lower coupler portion 152 can move relative to upper coupler portion 150. During this relative movement, a portion of upper coupler portion 150 can move further into the radial groove of lower coupler portion 152 and bumper 154 can be compressed. Additionally, cavity 156 can be compressed until it has a lower volume relative to a resting state or no volume. A portion of lower coupler portion 152 contacting a portion of upper coupler portion 150 to close cavity 156 can cause the lower coupler portion 152 to stop moving relative to upper coupler portion 150.

In one embodiment, upon contact with crossover ring 110, upper coupler portion 150 can translate in an opposite direction of movement of a damping rod 122 thus compressing bumper 154. Bumper 154 can isolate upper coupler portion 150 from lower coupler portion 152 and increase a deceleration rate of the two piece spring coupler. The two piece spring coupler with upper coupler portion 150, lower coupler portion 152 and bumper 154 can be a flexible spring coupler unit rather than a rigid member of traditional spring couplers. In one embodiment, upper coupler portion 150 can be preloaded by first spring 102 to prevent shuttling when not in contact with crossover ring 110.

During the compression event while the two piece spring coupler is moving toward crossover ring 110, first spring 102 may be compressing and shortening. After upper coupler portion 150 is in full contact with crossover ring 110 and lower coupler portion 152 is in full contact with upper coupler portion 150, first spring 102 may be stopped from further compressing at which point second spring 104 may begin to compress or further compress.

Lower coupler portion 152 moving relative to upper coupler portion 150 can compress bumper 154. Compressing bumper 154 can cause bumper 154 to deform. Compressing and deforming bumper 154 can reduce a noise and harshness of a jolt associated with the two piece spring coupler contacting crossover ring 110. Bumper 154 is depicted as being a ring with a round cross section such as an O-ring. It should be appreciated that bumper 154 can be any shape such as a ring with a ring with a square shaped cross section. During a rebound event, bumper 154 can decompress and return to a resting state thus moving upper coupler portion 150 apart from lower coupler portion 152.

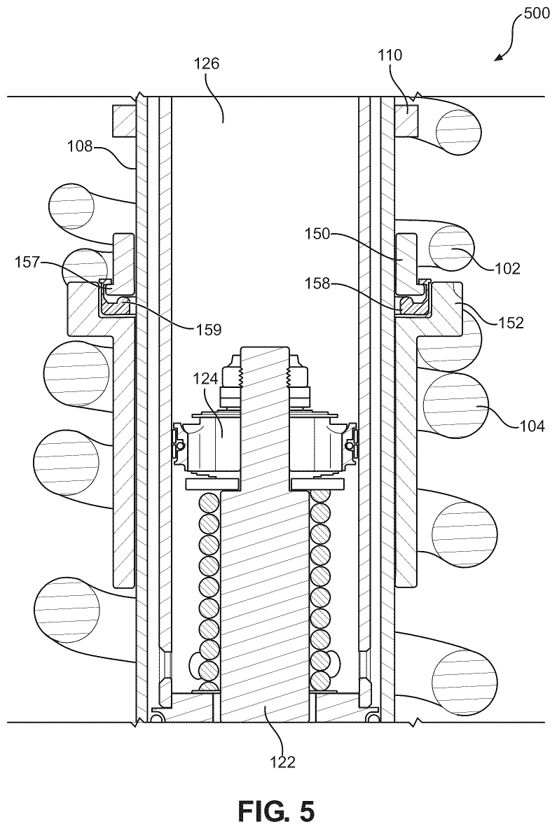

Referring now to FIG. 5, a cross section view of dual rate spring system 500 with a two piece spring coupler. Dual rate spring system 500 can be an alternate embodiment of dual rate spring system 400 of FIG. 4. Dual rate spring system 500 can have the same features and capabilities of dual rate spring system 400. Dual rate spring system 500 includes a two piece spring coupler including upper coupler portion 150 and lower coupler portion 152. In one embodiment, the two piece spring coupler of dual rate spring system 500 does not include a cavity such as cavity 156 of FIG. 4.

Bumper 158 of dual rate spring system 500 can be molded into a unique shape. Dual rate spring system 500 depicts upper coupler portion 150 having a flange 157. In one embodiment, bumper 158 can have an annular structure disposed about an outer surface of damper body 108 and a cross section of bumper 158 forms a shape that wraps around flange 157 of upper coupler portion 150 such that bumper 158 is positioned between upper coupler portion 150 and lower coupler portion 152. In one embodiment, the shape of bumper 158 prevents any portion of upper coupler portion 150 being able to contact any portion of lower coupler portion 152. In one embodiment, bumper 158 can be formed with a groove that forms a radial cavity 159 between a portion of upper coupler portion 150 and a portion of lower coupler portion 152. During a compression event, a portion of bumper 158 can compress and deform thus filling the radial cavity 159.

In one embodiment, bumper 158 is a molded shape. In one embodiment, bumper 154 is press fit compression fit into lower coupler portion 152. In one embodiment, bumper 158 can be preloaded by first spring 102 or the tender spring. In one embodiment, bumper 158 can be three dimensionally printed. The bumper 158 can serve to isolate upper coupler portion 150 from lower coupler portion 152.

Two Piece Spring Coupler with a Gas Chamber

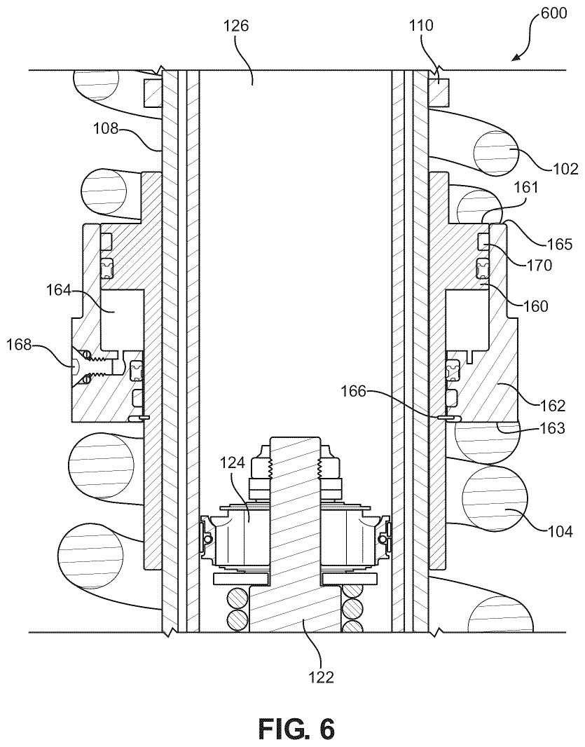

Referring now to FIG. 6, a cross section view of a dual rate spring system 600 with a two piece spring coupler including a gas chamber. In one embodiment, dual rate spring system 600 includes an inner coupler portion 160, an outer coupler portion 162, and a gas chamber 164 each having an annular structure. Inner coupler portion 160 is disposed about an outer surface of damper body 108. Outer coupler portion 162 is disposed about one or more surfaces of inner coupler portion 160. In one embodiment, inner coupler portion 160 slides or moves axially along a surface of damper body 108. In one embodiment, outer coupler portion 162 can move or slide axially along a surface of inner coupler portion 160.

Inner coupler portion 160 is depicted as having a spring seat 161 in contact with first spring 102. Inner coupler portion 160 may not contact an end of second spring 104 in an axially direction. Outer coupler portion 162 is depicted as having a spring seat 163 in contact with second spring 104. In one embodiment, a surface 165 of outer coupler portion 162 contacts first spring 102. In one embodiment, outer coupler portion 162 and inner coupler portion 160 are shaped to form gas chamber 164 which can be described as an annular or radial shaped cavity between inner coupler portion 160 and outer coupler portion 162. The volume and shape of gas chamber 164 can change as outer coupler portion 162 moves relative to inner coupler portion 160 during compression and rebound events of dual rate spring system 600.

In one embodiment, gas chamber 164 can be filled with a gas such as nitrogen or air. Gas can be added or removed from gas chamber 164 to change a pressure or volume of gas in gas chamber 164. Gas valve 168 can be employed to add or remove gas from gas chamber 164. Gas valve 168 can be a fill valve and can be a standard valve such as a Schrader valve. Retaining clip 166 can stop outer coupler portion 162 from movement in a downward direction such that outer coupler portion 162 may not be able to completely separate from inner coupler portion 160 and allow gas to escape from gas chamber 164. Retaining clip 166 can also allow gas chamber 164 to be pressurized before dual rate spring system 600 is fully assembled. First spring 102 being able to contact spring seat 161 of inner coupler portion 160 and surface 165 of outer coupler portion 162 can prevent inner coupler portion 160 from moving upward and separating completely from outer coupler portion 162. Pressure from damping piston 124 can also serve to maintain a seal of gas chamber 164. Thus gas pressure in gas chamber 164 can be maintained during movements of outer coupler portion 162 relative to inner coupler portion 160. Dual rate spring system 600 can include wear band 170 between inner coupler portion 160 and outer coupler portion 162. Dual rate spring system 600 depicts four wear bands between inner coupler portion 160 and outer coupler portion 162.

During a compression event, outer coupler portion 162 can be forced to move axially upward via a force from second spring 104. Inner coupler portion 160 can push on gas in gas chamber 164 and cause the gas to partially decompress and cause inner coupler portion 160 to move axially upward. The gas pressure in gas chamber 164 can be set or tuned to cause inner coupler portion 160 to move without fully compressing the gas in gas chamber 164. Then inner coupler portion 160 and outer coupler portion 162 can simultaneously move axially upwards until inner coupler portion 160 contact crossover ring 110. Once inner coupler portion 160 contacts crossover ring 110, inner coupler portion 160 may stop moving axially upwards while outer coupler portion 162 can continue to move relative to inner coupler portion 160 axially upwards thus reducing a volume of gas chamber 164 and compressing the gas in gas chamber 164. During a compression event, outer coupler portion 162 may or may not be able to completely eliminate the volume of gas chamber 164. This compression of gas in gas chamber 164 can act as a damper and thus reduce a noise or dampen a harshness of a jolt associated with the two piece spring coupler contacting crossover ring 110.

In one embodiment, outer coupler portion 162, inner coupler portion 160 and gas chamber 164 can act as an air spring when the two piece spring coupler contacts the crossover ring 110 and the dual rate spring system 600 changes from the spring rate of first spring 102 to the spring rate of second spring 104. The air spring of the two piece spring coupler can increase the transition time between the spring rate of first spring 102 to the spring rate of second spring 104. Gas valve 168 can provide for tuning of an air spring curve of the air spring. The air spring curve of the air spring can have a progressive curve. In one embodiment, the stroke length of the air spring of the two piece spring coupler is 0.585 inches. Such a stroke length can be increased or decreased in various embodiments. In one embodiment, a dead length could be reduced to gain stroke if damping piston 124 is molded out of nylon and the wear bands would not be needed.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A dual rate spring system with a two piece crossover ring, comprising:
a damper body with an axial length and housing a damping chamber with fluid, said damper body comprising:
a plurality of ports radially disposed about a surface of said damper body at a point along said axial length of said damper body for said fluid to move into and out of said damping chamber based in part on a position of a damping piston within said damping chamber;
a spring coupler for coupling a first spring with a first spring rate to a second spring with a second spring rate, wherein said spring coupler has an annular structure disposed about a surface of said damper body and is capable of sliding axially along said surface of said damper body, said spring coupler comprising:
a first spring seat for receiving said first spring;
a second spring seat for receiving said second spring;
a two piece crossover ring having an annular structure disposed about said damper body, said two piece crossover ring comprising:
an upper ring portion fixed in a position relative to said damper body along said axial length of said damper body;
a lower ring portion movable in an axial direction relative to said upper ring portion; and
a cavity formed by said upper ring portion and lower ring portion, said cavity filled with said fluid and in fluid communication with said plurality of ports, wherein a position of said lower ring portion relative to said upper ring portion changes a volume of said cavity.

2. The dual rate spring system of claim 1, wherein said fluid is displaced from said damping chamber to said cavity by said damping piston moving further into said damping chamber during a compression event, said fluid causing said volume of said cavity to expand and move said lower ring portion further from said upper ring portion.

3. The dual rate spring system of claim 1, wherein said spring coupler is capable of contacting a surface of said lower ring portion during said compression event causing said lower ring portion to move relative to said upper ring portion and reducing said volume of said cavity and displacing said fluid in said volume into said damping chamber via said plurality of ports.

4. The dual rate spring system of claim 1, wherein changing a size or number of said plurality of ports changes a fluid flow rate of said fluid between said damping chamber and said cavity to tune a damping effect of said two piece crossover ring.

5. The dual rate spring system of claim 1, wherein said first spring rate is less than said second spring rate.

6. A dual rate spring system with a two piece spring coupler, comprising:
a damper body with an axial length and housing a damping chamber with fluid;
a crossover ring having an annular structure disposed about said damper body and fixed at a point along said axial length of said damper chamber;
a two spring coupler for coupling a first spring with a first spring rate to a second spring with a second spring rate, wherein said two piece spring coupler has an annular structure disposed about a surface of said damper body and is capable of sliding axially along said surface of said damper body, said two piece spring coupler comprising:
an upper coupler portion partially in contact with said first spring;
a lower coupler portion comprising:
a first spring seat for receiving said first spring;
a second spring seat for receiving said second spring;
a groove for receiving a portion of said upper coupler portion;
an isolator configured to be positioned in said groove of said lower coupler portion, said isolator configured to deform during a compression event of said dual rate spring system when said upper coupler portion contacts said crossover ring and causes said upper coupler portion moves relative to said lower coupler portion.

7. The dual rate spring system of claim 6, wherein said isolator is in a shape of an O-ring.

8. The dual rate spring system of claim 6, wherein said upper coupler portion is shaped to form a cavity between said upper coupler portion and said lower coupler portion, and a movement of lower coupler portion towards said upper coupler portion closes said cavity when a surface of said lower coupler portion contacts a surface of said upper coupler portion within said cavity.

9. The dual rate spring system of claim 6, wherein said isolator is a molded shape that surrounds a flange of said upper coupler portion.

10. The dual rate spring system of claim 6, wherein said isolator is a shape that forms a groove between said upper coupler portion and said outer coupler portion and said isolator deforms to fill said groove when said upper coupler portion contacts said crossover ring and lower coupler portion moves relative to said upper coupler portion.

11. The dual rate spring system of claim 6, wherein said isolator is a shape isolates said upper coupler portion from contacting said lower coupler portion.

12. The dual rate spring system of claim 6, wherein said isolator is press fit or compression fit into said lower coupler portion.

13. The dual rate spring system of claim 6, wherein said isolator is a bumper that is composed of rubber, foam, and/or elastomer.

14. A dual rate spring system with a two piece spring coupler, comprising:
a damper body with an axial length and housing a damping chamber with fluid;
a crossover ring having an annular structure disposed about said damper body and fixed at a point along said axial length of said damper chamber;
a two spring coupler for coupling a first spring with a first spring rate to a second spring with a second spring rate, wherein said two piece spring coupler has an annular structure disposed about a surface of said damper body and is capable of sliding axially along said surface of said damper body, said two piece spring coupler comprising:
an inner coupler portion with a first spring seat for said first spring;
an outer coupler portion with a second spring seat for said second spring, said outer coupler portion partially in contact with said first spring; and
a gas chamber formed between said inner coupler portion and said outer coupler portion and filled with gas that is pressurized, wherein said outer coupler portion can move relative to said inner coupler portion and change a volume of said gas chamber.

15. The dual rate spring system of claim 14, further comprising:
a gas valve to add or remove said gas from said gas chamber.

16. The dual rate spring system of claim 14, further comprising:
a retaining clip coupled to said inner coupler portion to prevent said outer coupler portion from separating from said inner coupler portion.

17. The dual rate spring system of claim 14, wherein said outer coupler portion moves relative to said inner coupler portion after said inner coupler portion contacts said crossover ring during a compression event, reducing a volume of said gas chamber, and said gas in said gas chamber is further pressurized to dampen a contact between said two piece spring coupler and said crossover ring.

18. The dual rate spring system of claim 14, wherein said two piece spring coupler is an air spring.

19. A dual rate spring system with a two piece crossover ring and a two piece spring coupler, comprising:
a damper body with an axial length and housing a damping chamber with fluid,
a two piece crossover ring having an annular structure disposed about a surface of said damper body, said two piece crossover ring comprising a first damper; and
a two spring coupler for coupling a first spring with a first spring rate to a second spring with a second spring rate, wherein said two piece spring coupler has an annular structure disposed about a surface of said damper body and is capable of sliding axially along said surface of said damper body, said two piece spring coupler comprising a second damper.

20. The dual rate spring system of claim 19, wherein said damper body further comprises:
a plurality of ports radially disposed about a surface of said damper body at a point along said axial length of said damper body for said fluid to move into and out of said damping chamber based in part on a position of a damping piston within said damping chamber;
wherein said first damper of said two piece crossover ring further comprises:
an upper ring portion fixed in a position relative to said damper body along said axial length of said damper body;
a lower ring portion movable relative to said upper ring portion; and
a cavity formed by said upper ring portion and lower ring portion, said cavity filled with said fluid and in fluid communication with said plurality of ports, wherein a position of said lower ring portion relative to said upper ring portion changes a volume of said cavity.

21. The dual rate spring system of claim 19, wherein said second damper of said two piece spring coupler further comprises:
an upper coupler portion partially in contact with said first spring;
a lower coupler portion comprising:
a first spring seat for receiving said first spring;
a second spring seat for receiving said second spring;
a groove for receiving a portion of said upper coupler portion;
an isolator configured to be positioned in said groove of said lower coupler portion, said isolator configured to deform during a compression event of said dual rate spring system when said upper coupler portion contacts said crossover ring and causes said upper coupler portion moves relative to said lower coupler portion.

22. The dual rate spring system of claim 19, wherein said second damper of said two piece spring coupler further comprises:
an inner coupler portion with a first spring seat for said first spring;
an outer coupler portion with a second spring seat for said second spring, said outer coupler portion partially in contact with said first spring; and
a gas chamber formed between said inner coupler portion and said outer coupler portion and filled with gas that is pressurized, wherein said outer coupler portion can move relative to said inner coupler portion and change a volume of said gas chamber.
